(19) United States
(12) Patent Application Publication
(10) Pub. No.: US 2014/0279160 A1
(43) Pub. Date: Sep. 18, 2014

(54) AUCTION REPORT GENERATOR

(71) Applicant: Auction.com, LLC, Irvine, CA (US)

(72) Inventor: Sarina Kinder, Rancho Santa Margarita, CA (US)

(73) Assignee: Auction.com, LLC, Irvine, CA (US)

(21) Appl. No.: 14/214,664

(22) Filed: Mar. 15, 2014

Related U.S. Application Data
(60) Provisional application No. 61/852,235, filed on Mar. 15, 2013.

(51) Int. Cl. G06Q 30/08

(52) U.S. Cl. CPC G06Q 30/08
USPC 705/26.3

(57) ABSTRACT

A method and system for generating an auction report script are described. An inventory of possible assets to be auctioned is monitored during an auction event for changes in the assets' availability statuses. Script content is generated for an auctioneer based on the assets which have a status of available for auction, and the content of this script is repeatedly updated during the auction event.

### RELATED APPLICATION

This application claims the benefit of priority to Provisional U.S. Patent Application No. 61/852,235, filed Mar. 15, 2013, entitled AUCTION REPORT GENERATOR; the aforementioned priority application being hereby incorporated by reference in its entirety.

### TECHNICAL FIELD

Examples described herein relate to an auction report generator for facilitating auctioneers in live auctions.

### BACKGROUND

Embodiments recognize that few mechanisms exist for participants in a live auction to learn about changes in auction assets in real time. Embodiments further recognize that many parties may provide assets for sale in the course of an auction and the status of the assets can be in flux.

### BRIEF DESCRIPTION OF THE DRAWINGS

FIG. 1 illustrates an example system for generating an auctioneering report in a networked environment.

FIG. 2 illustrates an example method for generating an auctioneering report in a networked environment.

FIG. 3A illustrates sample content of a generated script to be read by an auctioneering entity during an auction event.

FIG. 3B illustrates a sample interface on a recipient device configured to receive content of a generated script.

FIG. 4 is a block diagram that illustrates a computer system upon which embodiments described herein may be implemented.

### DETAILED DESCRIPTION

Embodiments as described herein recognize that some live auctions provide an asset pool that is in flux throughout the auction event. For example, assets in the asset pool of a live auction can, in some instances, be added to the auction pool, placed on hold pending further consideration, or removed from the auction pool entirely. The change in status of the various assets can occur prior to or during the auction event itself. For example, when the auction begins, there may be a queue of assets that are auctioned sequentially, and as the auction event progresses, assets in the queue may change status. Conventional approaches provide that at such auction events, auctioneers and other participants at the event often use manual prompts, handouts, or other media which is not updated in real time. As a consequence, auctioneers sometimes misstate an asset being auctioned, or conduct the auction with very little preparation and knowledge regarding the asset.

Accordingly, embodiments recognize that there are many live auctions in which the asset pool is dynamic or in flux, so that the status of assets on auction may change rapidly. For example, an asset that is to be auctioned at a start of an auction event may have its status changed, so that it is taken out of the available asset pool as the auction progresses. Conventional approaches rely on media (e.g., print media) which is not updated frequently during the auction event. The conventional media is also typically not a reliable source of what assets are actually available for auction, given the change of status that occurs to the assets. Consequently, the auctioneers of live auctions typically have to deal with inherent disorganization and disruption as new information is made known about the changing asset pool. This can cause auctioneers to make mistakes, lose fluidity or speak without knowledge of an asset being auctioned.

Embodiments further recognize that for many live auctions, controlling the asset pool is outside of the control of the auction host or provider. Rather, examples described herein provide a mechanism to enable the auctioneer to speak accurately and with knowledge in the presence of rapid changes to the asset pool of the auction. More specifically, examples described herein provide a mechanism where the auctioneer is provided information that identifies the available assets of the auction pool accurately, and continuously throughout the auction event.

Many examples described herein relate to trustee real estate auctions, in which there is considerable flux in the assets before and even during the auction. In such trustee auctions, homes under foreclosure can be cleared for auction, the foreclosure notice can be canceled just prior to auction, or the home may be placed on hold pending further legal processing. In this environment, the auctioneer can readily make errors in what asset is identified for auction, how the asset is described, and what preparation the auctioneer has before the auction is initiated. In particular, examples described herein provide the auctioneer with an electronic report that is updated repeatedly over the course of an auction, and includes proper identification of assets that are available for auction at a current instance in time. In some variations, the auctioneer may also be provided text content in the form of a script to facilitate the auctioning of assets further.

In an example, an inventory of possible assets for auction is updated during an auction event. During the auction event, the system receives asset updates which indicate changes in the auction availability status of some of those assets. For example, an asset which was previously listed for auction may be removed, or an asset which was pending may be added to the list of available items for auction. The system updates the inventory of possible assets with the new availability information. In one embodiment, the assets correspond to real property items (e.g., a house, land, etc.) and the auction event is a trustee sale.

A live auction can refer to an auction that is attended by persons and is conducted in real-time. While examples described herein pertain primarily to live auctions, examples recognize hybrid auctions which include live aspects (e.g., persons present at auction site) combined with network functionality (e.g., communicating auction events or content over the Internet).

According to some examples, the system generates content for a portion of a script to be used by an auctioneering entity. In addition, additional text content may be added to the script beyond what is necessary to describe the asset and its status. For example, the auctioneering entity may be an auctioneer at a live auction event, and the script may be formatted as prose to be read aloud by the auctioneer.

As used herein, the auctioneer can correspond to a human or a computer-implemented process that simulates a human.

In one example, the content of the script is repeatedly updated during the auction event as auction events are received. The updated script may then be sent to the auctioneering entity and can indicate new assets for auction or assets that have had their status changed since the last update.

Furthermore, the content of the script may be adapted for use on a recipient device, such as for participants and potential bidders at the auction event. A recipient device may include cell phones, tablets, personal computers, or other such computing devices. The script can be adapted to fit the format of an application, such as for a mobile device, or a website that may be accessed over a network using a browser.

Some examples described herein pertain primarily to distressed assets, such as real-estate, in which a lender has initiated a process to sell the asset to pay off a secured debt. Although distressed assets can include any type of item, product, vehicle, real property, etc., having a loan associated with it, for illustrative purposes, examples are provided with respect to real property. According to examples, the status of an asset represents whether the asset will be available for the scheduled auction event and can correspond to at least one of (i) cleared for auction, meaning the item is available for auction, (ii) pending, or (iii) canceled.

The terms “during an auction,” or “the duration of an auction” can refer to a duration of time that starts from the listing of an asset to be auctioned, through the bidding process and completion of the bidding process (e.g., through completion of the auction), and ends at a time during or after the closing period of the asset transaction or when the asset is finally transferred to the buyer. The term “asset” can refer to a tangible item or a product. Examples of an asset can include any item for sale, a vehicle, an antique, real estate property, etc. Types of real estate property can include a house, a townhouse, a condo, an apartment, a business property, land, etc. Also, a “user” can refer to a bidder (or potential bidder), buyer of an asset at an auction, or an auctioneering entity conducting the auction event.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, a software component, or a hardware component capable of performing one or more stated tasks or functions. In addition, a module or component can exist on a hardware component independently of other modules or components. Alternatively, a module or component can be a shared element or process of other modules, programs or machines.

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer programs.

System Description

FIG. 1 illustrates an example system for generating an auctioneering report for a live auction. In an example of FIG. 1, system 100 is implemented as part of a network service that utilizes one or more terminals 11 local to the site of the live auction. The terminals can correspond to, for example, handsets (e.g., smart phones, tablets), desktop computers and other computing devices which can generate output corresponding to an auctioneering report. Accordingly, system 100 can be implemented through a combination of servers and/or other network-enabled computing devices. In variations, system 100 can be implemented on other computing platforms, including stand-alone systems. Thus, in some variations, system 100 can operate on a product or service that is maintained on a single computing or storage device. Furthermore, some elements of the embodiment of FIG. 1 may be implemented using elements on a user's computing environment. Accordingly, some embodiments provide that some elements of FIG. 1 are implemented as a run-time system that executes as part of another process. Other embodiments provide that some elements of FIG. 1 are implemented by an application that functions on a client device. Further embodiments provide that other elements of FIG. 1 are implemented by an auction provider.

In an example of FIG. 1, the components of system 100 can combine to generate an auction report using input that identifies assets for an asset pool of a live auction, and further utilizes near real-time status information about the assets in the asset pool. The status information can reflect the availability status of individual assets for auctioning. In trustee or foreclosure auctions, for example, an initial asset pool can identify a larger list of assets which are candidates for auction, and the status of these assets changes throughout a period preceding an auction event and even during the auction event. For example, as the auction time approaches, the original owners of the assets and lenders perform actions that result in some of the assets being placed on hold or removed from the asset pool altogether. Accordingly, in some examples, one or more assets may be removed, postponed, or added to the list of items that are to be auctioned, either before the auction event begins or during the auction event itself.

System 100 can generate an auction report that includes a list of assets in an asset pool. At a given auction event, those assets in the asset pool which have status information indicating available to be auctioned are then queued and auctioned. Remaining assets in the asset pool can held in the asset pool until the next auction event. The system 100 can also generate the report to include portions of a script that can identify assets for oral communication, and further provide some description of the individual assets being auctioned. The auction report can be provided for an auctioneering entity or other auction participants for use during the auction event. The auction report can be updated repeatedly throughout the auction event.

System 100 includes one or more asset interface 105 that communicate with one or more asset listing sources to receive asset information 103. The asset information 103 can include information obtained from asset sources that (i) identifies assets for the asset pool, and (ii) updates status information about the asset in the asset pool. The system 100 can generate an updated auction report that includes the current asset pool, as determined from updated status information. The auction report can be provided to the auctioneering entity, and optionally to the auction participants. In an example of FIG. 1, system 100 includes asset interfaces 105 that includes a foreclosure interface 106 and an owner interface 108. The foreclosure interface 106 can communicate over a network with one or more foreclosure asset providers 102. Foreclosure asset providers 102 can include computer systems operated by foreclosure agents, who take steps to foreclose on a real property asset. For example, the foreclosure asset providers 102 can include terminals that operate software in which the foreclosure agents can provide input to identify assets ready for foreclosure, as well as status changes of previously identified assets. The owner interface 108 can communicate over a network with owner asset providers 104. The owner asset providers 104 can include owners and their respective agents who either add assets to the asset pool managed by system 100, or who perform steps or actions to remove assets from the pool. For example, it is very common for owners to take legal and financial steps to remove the foreclosure status of their homes. The owner interface 108 can interface with owner asset provider 104, corresponding to computers and terminals operated by owners and/or their respective agents in order to receive input that adds an asset to the asset pool and/or changes the status of the existing asset in the asset pool. As mentioned, the status change can correspond to input (e.g., legal documentation, proof of payment etc.) that directs the authority of the auction event to remove or change status of an asset in the asset pool. The status changes provided by either the foreclosure or owner asset providers 102, 104 can remove an asset from the asset pool entirely, place an asset in “pending status” (from “cleared for auction”) or place an asset in “cleared for auction” status (from “pending status”). Those assets in the asset pool which have “pending” status when the auction event is over can be maintained in the asset pool for the next auction event (unless removed at a subsequent time).

In some implementations, the asset interfaces 105 can also include government foreclosure resources, including public resources which can include records that identify assets such as distressed real-estate (e.g., homes subject to foreclosure or trustee sale). The asset interface 105 can, for example, interface public records to determine the newly listed assets and status information for existing assets of the asset pool.

Accordingly, a system of FIG. 1 recognizes that system 100 can be implemented in conjunction with an asset pool that is in flux. For example, depending on government regulations, when a bank or mortgage holder initiates a foreclosure process on an asset, foreclosure asset provider 102 (e.g., a trustee) can, or may be obligated to, publish information about the asset. The foreclosure asset provider 102 can maintain an asset listing that includes a plurality of assets. Each asset can include asset information that describes the asset and/or identifies the state of the asset in terms of being ready for auction. During the foreclosure process, the status of these assets can change depending on various circumstances, such as if the owner pays off the loan owed. The trustee can update the asset listing with this newly changed asset information 103.

In more detail, some embodiments provide that the foreclosure interface 106 provides a mechanism for a foreclosure asset provider 102 to identify and update items. The foreclosure interface 106 can receive and communicate asset information 103 to the asset manager 110. The asset information 103 received by the asset manager 110 (i) identify new assets for auction events, (ii) provide status information for new assets, and/or (iii) update status information of previously submitted assets of the asset pool. In this way, the foreclosure asset provider 102 can add assets for auctioning, or change the status of an item for auction (e.g., from pending to canceled, or from pending to cleared for auction). Examples provide for foreclosure interface 106 to receive information (e.g. asset listings) concerning assets which are under foreclosures (e.g. real estate). As such, examples provide for foreclosure interface 106 to receive updated foreclosure information about assets as a foreclosure process continues. The foreclosure interface 106 operates to receive updates in real time. For example, additional assets may come under foreclosure and be subject to auction (i.e., assets are added to the auction event).

As an addition or alternative, the owner interface 108 can provide a mechanism to receive and communicate asset information 103 from one or more owner asset providers 104. In some implementations, the owner interface 108 obtains status information for existing assets of the asset pool. In one example, each of the interfaces (e.g., foreclosure interface 106, owner interface 108) can monitor for changes in assets by periodically polling asset sources such as the foreclosure asset provider 102 and/or owner asset provider 104. Additionally, one or more of the interfaces, such as the owner interface 106, can receive input initiated from an external source to change the status of an asset in the asset pool. For example, owners can update the status of their home under foreclosure to reflect a change in status that cancels an otherwise scheduled auction. In some cases, an asset listing can be maintained by a trustee, such as an agent or a representative hired by a bank or mortgage holder of an asset. Depending on examples, such an asset can be a distressed asset or an asset having a debt (e.g., on a loan) that is associated with that asset and that is under a foreclosure order. As such, examples provide for owner interface 108 to receive information which places assets out of auction.

The asset manager 110 includes programmatic processes or components which receive and structure asset information 103 from the asset interfaces 105. More specifically, in one implementation, the asset manager 110 can receive status and asset input 125, 127 (as determined from asset information 103) and structure the information of the inputs as records that correspond to a collection of asset listings 113 in a data store 115. The asset listings 113 can identify the asset (e.g., by address or parcel), include auction availability status 109 (e.g., “cleared for auction” “pending” or “canceled”), date information that identifies when the asset can be sold and some descriptive information (e.g., type of real property, size, etc.). The asset manager 110 can manage the asset pool of a given auction by generating one or more schedules 131 using scheduling logic 112. The scheduling logic 112 can include a calendar that identifies dates when individual listings 113 can first be made available for transaction. The scheduling logic 112 can also generate a sequence that specifies the order in which individual listings 113 are auctioned at a given auction event.

For a given auction, the asset data store 115 can be updated up to the start of the auction event, and also during the auction event, as the auction event progresses through the asset pool. The updates to the data store 115 can correspond to identification of new assets and updates to statuses of the assets in the asset pool. For example, the asset manager 110 can receive a status input 125 from owners (e.g., owner asset provider 104), from a foreclosure asset provider 102, or from another source (e.g., lender, public city, etc.). The status input 125 can be linked to the status 109 of the listing 113 identified by the owner. Likewise, the asset manager 110 can receive asset information from foreclosure asset providers 102, and the asset manager 110 can generate new listings 113 for the asset data store 115. As mentioned, the status information can direct the auctioneer to change the status of an existing asset from, for example, “cleared for auction” to “pending” or “canceled.”

In one implementation, the data store 115 maintained by the auction manager 110 includes records (asset listings 113) which correlate an identifier of each asset in the asset pool with the status 109 of that asset. Either of the asset interfaces 105 (e.g., owner interface 108) can receive asset information 103 from asset provider 104, and signal (i) status input 125 to alter the status of an existing asset in the asset pool, or (ii) asset input 127 to identify a new asset for the asset pool. The status of each asset can correspond to, for example, “cleared for auction”, “canceled”, and “pending.” Date information can also be provided with the status input 127, indicating, for example, the date when the asset can be made available. As an addition or alternative, descriptive information can also be provided with the asset input 127 and maintained as part of the records of the asset store 115.

The asset and status input 127, 129 provided to asset manager 110 can be structured as asset records 113 by the asset manager 110 and stored with the data store 115. For example, the asset records 113 can be structured for a database, or alternatively in a format such as XML or CVS.

In some embodiments, the schedule 112 specifies scheduling and date information for individual assets, as identified by identifiers of the asset listings 113. The scheduling information 131 can also be stored in the data store 115, for use in scheduling auction events.

In one implementation, content generator 120 can generate reports by querying the data store 115 on a repeated or continuous basis throughout the course of an auction event, including a period preceding the auction event (e.g., the evening before, hours before etc.). For example, at a given instance, the content generator 120 can signal a query 129 to the data store 115 to identify those available assets 137, correspond to assets of the asset pool that have the status of being available at that particular time. The scheduling information 131 associated with the queried assets can further dictate the sequence or order in which those assets are to be auctioned on the particular auction event. The content generator 120 can repeatedly (e.g. every 30 minutes or after every auction) query the data store 115 to identify the updated set of available assets 137. Additionally, the content generator 120 can receive status updates for assets that were previously listed as available (e.g., “cleared for auction”), but no longer available. The content generator 120 can also utilize the scheduling information 131 associated with the assets, so that a resulting list 122 maintained by the content generator 120 is continuously up-to-date.

An report 125 of the content generator 120 can be provided to an auction interface 130. The auction interface 130 includes a computing device that outputs content for an auctioneer at the site of the live auction. By way of example, the auction interface 130 can include a mobile device 140, such as a tablet or mobile computing device that the auctioneer can carry with him when conducting to live auction. Still further, the auction interface 130 can include a network connected Teleprompter 142. In variations, the auction interface 130 can correspond to an on-site printer which repeatedly generates hardcopies corresponding to an auction report for the auctioneer.

The report 125 of the content generator 120 can be based on the list 122, which represents those assets that are “clear for auction.” In some variations, the report 125 can include additional content, corresponding to script, phrases, words, and/or other descriptive material which can highlight features or characteristics of the asset. In this way, the auctioneer gets not have to generate sales content without having any advance knowledge of the particular asset.

In some variations, the report 125 of the content generator 120 includes a script (e.g., text content that is read aloud) that is particularly suited for an auctioneer. As an addition or variation, the report 125 can be generated as a hard copy and distribute to both the auctioneer and participants of the live auction.

In some implementations, the auction interface 130 includes interactive elements which enable the auctioneer to interact with the script report 125 of the content generator. By way of example, the auctioneer can scroll to identify next product listing. The auction interface 130 may also provide signals to a person reading the script 121 (e.g., by providing sound, vibrations, visual indicators that a new update has been received, etc.). In another embodiment, the report 125 is received by a messaging system (e.g., e-mail, SMS messaging) that is operated by the auctioneer (e.g., through a smart phone).

When an asset is sold (“cried”), in entity of the auction can mark the transaction. In one implementation, the auction interface 130 signals the transaction event back to the content generator 120, which saves information with the data store 115. For example, the auctioneer can provide input that indicates the auction occurred and the property was sold. This information can then reflect that the asset is no longer available for auction.

Methodology

FIG. 2 illustrates an example method for generating an auctioneering report in a networked environment. While operations of the method 200 are described below as being performed by specific components, modules or systems of the computer system 100, it will be appreciated that these operations need not be performed by the specific components identified, and could be performed by a variety of components and modules, potentially distributed over a number of machines. Accordingly, references may be made to elements of system 100 for the purpose of illustrating suitable components or elements for performing a step or sub step being described. Alternatively, at least certain ones of the variety of components and modules described in system 100 can be arranged within a single hardware, software, or firmware component. It will also be appreciated that some of the steps of this method may be performed in parallel or in a different order than illustrated.

With reference to an example of FIG. 2, the asset manager 110 manages the intake of listings 103 from different asset providers 105 (e.g., foreclosure asset providers 102) (204). In one implementation, the foreclosure interface 106 periodically polls multiple foreclosure asset providers 102 for information 103 about new or existing asset listings 113. Likewise, owner interface 108 receives or otherwise interfaces with owner asset providers 104 (e.g., computers operate the owners) to receive information about new or existing asset listings 113.

The acquired asset information 103 is communicated to the asset manager 110 as asset information 127 and status information 125, where the information is used to update the asset pool of the auction (208). In an example, asset information 103 for each asset identifies (i) an asset ID (identifying the particular asset) and (ii) an asset status for the asset (e.g. (i) cleared for auction, (ii) pending, or (iii) canceled). In one implementation, the asset manager 110 can parse or otherwise analyze asset information 103 provided through the foreclosure interface 106 in order to determine the identifiers and status of individual assets. This information can be stored in the asset store 115 as asset listings 113.

The content generator 120 can generate content for the auctioneer (212). This content can identify the asset, such as the address for a piece of real property. The content can also include other information, such as status information or the date and time when the asset was cleared. The content can also include a script, which can, for example, identify information for conducting an auction. This information can include, for example, a starting price for bidding and particular features of the asset, such as square footage, number of rooms, etc.

In one example, content generator 120 can generate additional textual content to include in the script 121 (216). This content may include, for example, prose formatted to be read during a live auction event by an auctioneering entity (e.g., an auctioneer) (222). Alternatively, the auctioneering entity may be a computer program and the additional textual content could be read, for example, by a text-to-speech algorithm or displayed on a screen for participants to read (224).

In some variations, content generator 120 generates the report 125 corresponding to text content (e.g., script 121) for all assets in the inventory before the auction event begins. In variations, the content generator 120 generates the report 125 corresponding to text content (e.g., script 121) continuously or repeatedly as the auction event progresses, so that the auctioneer is provided text content with updated information about the asset pool throughout the auction event. For example, multiple instances preceding and during the auction, the content generator queries the data store 115 for those assets which are “cleared for auction.” The content generator 120 can generate the report 125, and further update the report 125 repeatedly once new information is obtained from querying the data store 115. For example, report 125 may provide a list, that is updated based on changes to status information and new listings, as received through, for example, the foreclosure interface 106 or the owners interface 108. Once the output 225 is updated, the auction interface 130 can provide script 121 to the auctioneer to reflect updated information (228).

### EXAMPLES

FIG. 3A illustrates sample content of an auctioneer script 310, according to one or more embodiments. The auctioneer script 310 can correspond to the report 125 from the content generator 120. The auctioneer script 310 can be output on a tablet, Teleprompter, or other computing device held or otherwise operated by the auctioneer during the live auction. In the example provided, the auctioneer script 310 identifies an event identification number and a starting time, which tells the auctioneer when to begin the auction. After a short preamble in this example, the auctioneer script 310 contains details pertaining to the first item up for bidding, which is available for auction.

A portion of the script 310 can include non-specific prose that can facilitate the auctioneer. This prose can include a generic script, for example, as an introduction.

The second item 311 up for auction, on the other hand, is indicated on the auctioneer script 310 as being newly received. For example, the auctioneer can be alerted that a new entry is inserted into the script, based on sequencing or ordering as determined by the asset manager 110

In an example of FIG. 3A, an asset that was to be auctioned can have its status changed (e.g., to “pending” or “canceled”) and this change in status can be reflected on the auctioneer script 310. Alternatively, the item that has a status change can be removed from the auctioneer script 310.

FIG. 3B illustrates a sample interface on a user device 350 configured to receive report 125 from the content generator 120. In the example provided, the output 124 includes an event identification number and a starting time, which tells the auctioneer (or other participant if report is published) when the auction will begin. Also displayed on this page of the device's screen are four properties, each with corresponding details, opening bid amounts, and auction availability statuses.

Asset #1 in this example is available for auction at an opening bid of $100,000 according to the script 121. On the other hand, asset #2 is marked as pending and therefore will not be available for bidding unless its status is updated to available during the auction event by, for example, a foreclosure asset provider 102 entering asset information 103 for asset #2 on the foreclosure interface 106.

Continuing this example, asset #3 was apparently part of the script 121 and therefore available at or near the start of the auction event, but it has since been canceled and removed from the inventory 116 of available assets (351). For example, a owner may have retrieved asset #3 from foreclosure at the last minute and entered this information using owner interface 108.

Asset #4 in this example, on the other hand, is now available when it was not at the start of the auction, according to the information displayed on the user device 350 (352). As with asset #3, content generator 120 has updated the script 121 and made it available to the user device 350 through auction interface 130 so that auction participants have the latest and most up-to-date information regarding assets up for bidding at this auction event.

In this user device 350 example, a number of user interface elements 353 are provided. Such elements can be used by auction participants to interact with auction interface 130 to perform tasks such as updating the script 121, seeing more inventory items available, checking on other auction events, and entering profile information into the application.

Computer System

FIG. 4 is a block diagram that illustrates a computer system upon which embodiments described herein may be implemented. For example, in the context of FIG. 1, system 100 may be implemented using one or more servers such as described by FIG. 4.

In an embodiment, computer system 400 includes processor 404, memory 406 (including non-transitory memory), storage device 410, and communication interface 418. Computer system 400 includes at least one processor 404 for processing information. Computer system 400 also includes the memory 406, such as a random access memory (RAM) or other dynamic storage device, for storing information and instructions to be executed by processor 404. The memory 406 also may be used for storing temporary variables or other intermediate information during execution of instructions to be executed by processor 404. The memory 406 may also include a read only memory (ROM) or other static storage device for storing static information and instructions for processor 404. The storage device 410, such as a magnetic disk or optical disk, is provided for storing information and instructions. The communication interface 418 may enable the computer system 400 to communicate with one or more networks through use of the network link 420 and any one of a number of well-known transfer protocols (e.g., Hypertext Transfer Protocol (HTTP)). Examples of networks include a local area network (LAN), a wide area network (WAN), the Internet, mobile telephone networks, Plain Old Telephone Service (POTS) networks, and wireless data networks (e.g., WiFi and WiMax networks).

Embodiments described herein are related to the use of computer system 400 for implementing the techniques described herein. According to one embodiment, those techniques are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. In alternative embodiments, hard-wired circuitry may be used in place of or in combination with software instructions to implement embodiments described herein. Thus, embodiments described are not limited to any specific combination of hardware circuitry and software.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method for managing an auction event, the method being implemented by one or more processors and comprising:
updating an asset pool over at least a portion of a duration of the auction event, wherein at least some assets of the asset pool change status over the course of the auction event as between being available for auction and not being available for auction;
generating content for a script for an auctioneer, the content being based on assets of the asset pool that have a status of being available for auction when the content is generated; and
updating the content repeatedly over at least the portion of the duration of the auction event based on input from external sources that affect the availability of the status.

2. The method of claim 1, wherein updating the asset pool includes:
receiving an asset update during the duration of the auction event, the asset update indicating whether an asset of the asset pool is available or not available for auctioning; and
updating the asset pool to include the received asset update.

3. The method of claim 1, wherein at least some assets of the asset pool are real property items available for auctioning at a trustee sale.

4. The method of claim 1, wherein generating the script includes generating text content that is in addition to text that identifies the assets of the asset pool that have a status of being available for auction.

5. The method of claim 1, further comprising:
transmitting the content of the script to a recipient device of the auctioneer.

6. The method of claim 1, wherein the auction event is a trustee sale.

7. The method of claim 1, further comprising scheduling auctions for individual assets of the asset pool at the auction event, based on the status of the individual assets.

8. A system comprising:
one or more network interfaces;
one or more memory resources; and
one or more processors coupled to the one or more network interfaces and the one or more memory resources, the one or more processors to:
update an asset pool over at least a portion of a duration of the auction event, wherein at least some assets of the asset pool change status over the course of the auction event as between being available for auction and not being available for auction;
generate content that includes a script for an auctioneer, the content being based on assets of the asset pool that have a status of being available for auction when the content is generated; and
update the content of the script repeatedly over at least the portion of the duration of the auction event.

9. The system of claim 8, wherein the one or more processors update the asset pool by:
receiving an asset update during the duration of the auction event, the asset update indicating whether an asset of the asset pool is available or not available for auctioning; and
updating the asset pool to include the received asset update.

10. The system of claim 8, wherein at least some assets of the asset pool are real property items available for auctioning at a trustee sale.

11. The system of claim 8, wherein the one or more processors generate the script by generating text content that is in addition to text that identifies the assets of the asset pool that have a status of being available for auction.

12. The system of claim 8, wherein the one or more processors:
transmit the content of the script to the recipient device of the auctioneer.

13. The system of claim 8, wherein the one or more processors schedule auctions for individual assets of the asset pool at the auction event, based on the status of the individual assets.

14. The system of claim 8, wherein the auction event is a trustee sale.

15. A non-transitory computer-readable medium storing instructions that, when executed by one or more processors, cause the one or more processors to:
update an asset pool of possible assets over at least a portion of a duration of the auction event, wherein at least some assets of the asset pool change status over the course of the auction event as between being available for auction and not being available for auction;
generate content that includes a script for an auctioneer, the content being based on assets of the asset pool that have a status of being available for auction when the content is generated; and
update the content of the script repeatedly over at least the portion of the duration of the auction event.

16. The non-transitory computer-readable medium of claim 15, wherein instructions for updating the asset pool includes instructions for:
receiving an asset update during the duration of the auction event, the asset update indicating whether an asset of the asset pool is available or not available for auctioning; and
updating the asset pool to include the received asset update.

17. The non-transitory computer-readable medium of claim 15, wherein at least some assets of the asset pool are real property items available for auctioning at a trustee sale.

18. The non-transitory computer-readable medium of claim 15, wherein instructions for generating the script includes instructions for generating text content that is in addition to text that identifies the assets of the asset pool that have a status of being available for auction.

19. The non-transitory computer-readable medium of claim 15, further comprising instructions for:
transmitting the content of the script to a recipient device of the auctioneer.

20. The non-transitory computer-readable medium of claim 15, further comprising instructions for scheduling auctions for individual assets of the asset pool at the auction event, based on the status of the individual assets.
